(19) United States
(12) Patent Application Publication
(10) Pub. No.: US 2011/0102595 A1
(43) Pub. Date: May 5, 2011

(54) NETWORK AUDIO/VIDEO CAPTURING SYSTEM AND METHOD

(75) Inventors: YANG-YUAN CHEN, Tu-Cheng (TW); MING-CHIH HSIEH, Tu-Cheng (TW)

(73) Assignee: HON HAI PRECISION INDUSTRY CO., LTD., Tu-Cheng (TW)

(21) Appl. No.: 12/634,693

(22) Filed: Dec. 10, 2009

(30) Foreign Application Priority Data
Nov. 5, 2009 (CN) 200910309358.1

(51) Int. Cl. H04N 7/18

(52) U.S. Cl. 348/159; 348/143; 348/207.1; 348/E07.085

(57) ABSTRACT

A network camera includes a capturing unit, a video converter, an audio converter, a microprocessor, and a signal sending unit. The capturing unit captures an analog video signal and an analog audio signal. The video converter converts the analog video signal to a digital video signal; the audio converter converts the analog audio signal to a digital audio signal. The microprocessor superposes and compresses the digital video signal and the digital audio signal and outputs a first universal serial bus (USB) signal. The signal sending unit converts the first USB signal to a wireless USB signal.

### BACKGROUND

1. Technical Field

The present disclosure relates to a network audio/video capturing system and a network audio/video capturing method.

2. Description of Related Art

Network cameras are typically employed for monitoring locations. Using a dedicated network audio/video (A/V) recorder or audio/video management software in a computer, A/V data from all the cameras are recorded simultaneously. For example, each of the network cameras captures the A/V data, and transmits the A/V data to the computer. Before transmitting the A/V data to a network, the computer has to compress the A/V data. That is, the network cameras do not have data compression functions.

### BRIEF DESCRIPTION OF THE DRAWINGS

FIG. 1 is a block diagram of an embodiment of a network audio/video capturing system, the network audio/video capturing system including a number of network cameras.

FIG. 2 is a block diagram of one embodiment of one of the network cameras of the network audio/video capturing system of FIG. 1.

FIG. 3 is a flowchart illustrating one embodiment of a network audio/video capturing method.

### DETAILED DESCRIPTION

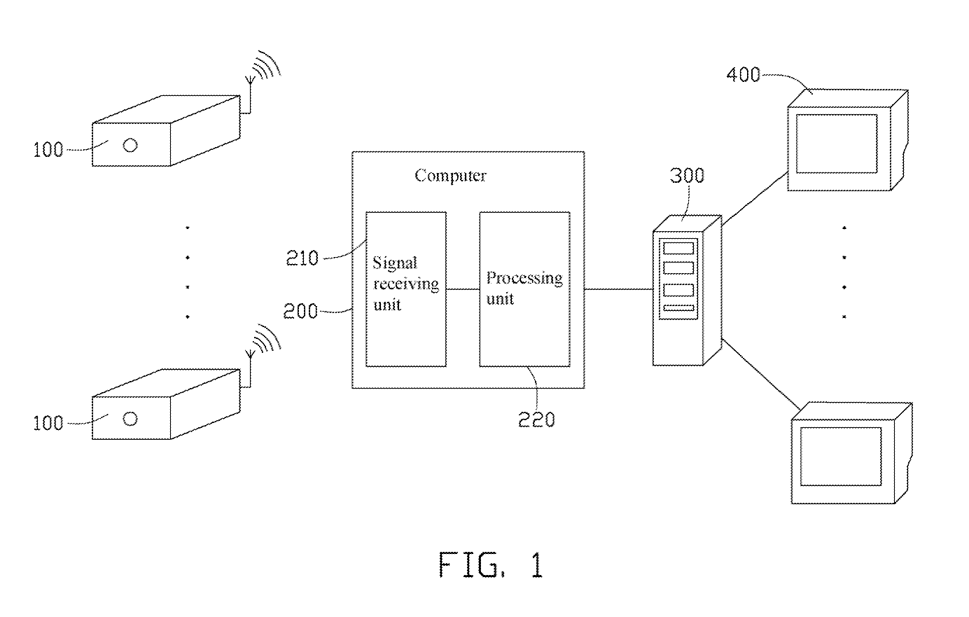

Referring to FIG. 1, an exemplary embodiment of a network audio/video (A/V) capturing system includes a plurality of network cameras 100, a computer 200, a server 300, and a plurality of network terminals 400.

Each of the plurality of network cameras 100 communicates with the computer 200 via a wireless network.

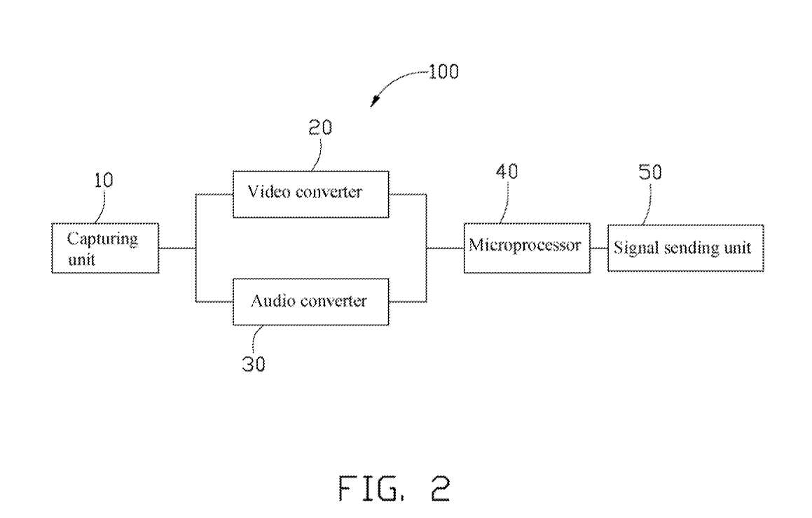

Referring to FIG. 2, one of the network cameras 100 is shown and includes a capturing unit 10, a video converter 20, an audio converter 30, a microprocessor 40, and a signal sending unit 50.

The capturing unit 10 is placed in an area to be monitored to capture an analog audio and video signals.

The video converter 20 and the audio converter 30 are connected to the capturing unit 10. Both of the video converter 20 and the audio converter 30 are analog-to-digital converters. The video converter 20 converts the analog video signal to a digital video signal. The audio converter 30 converts the analog audio signal to a digital audio signal.

The microprocessor 40 is connected to the video converter 20 and the audio converter 30, to superpose and compress the digital video signal and the digital audio signal. The microprocessor 40 outputs a first universal serial bus (USB) signal.

The signal sending unit 50 is a radio apparatus and is connected to the microprocessor 40. The signal sending unit 50 receives the first USB signal and converts the first USB signal to a wireless USB (WUSB) signal. The signal sending unit 50 sends the WUSB signal to the computer 200.

The capturing units 10 of the plurality of network cameras 100 may be placed in different positions in the area to be monitored, to monitor the area from different angles or may be place in different areas with entirely different views. The plurality of network cameras 100 may be turned on in turn to communicate with the computer 200.

Each of the plurality of network cameras 100 has an identification (ID). The computer 200 can distinguish the network cameras 100 by their unique IDs. Before communicating with the computer 200, a network camera 100 sets its ID as “1” and detects the IDs of other network cameras 100 communicating with the computer 200. The network camera 100 increments its ID by 1 if there is a same ID already in use, until it has found a unique ID.

The computer 200 includes a signal receiving unit 210 and a processing unit 220. The signal receiving unit 210 receives the WUSB signal of the network camera 100 and converts the WUSB signal to a second USB signal. The processing unit 220 converts the second USB signal to network data and sends the network data to the server 300.

The server 300 is allocated to store the network data.

The network data can be transmitted to the plurality of network terminals 400. Each of the plurality of network terminals 400 decodes and converts the network data to analog video signals and analog audio signals.

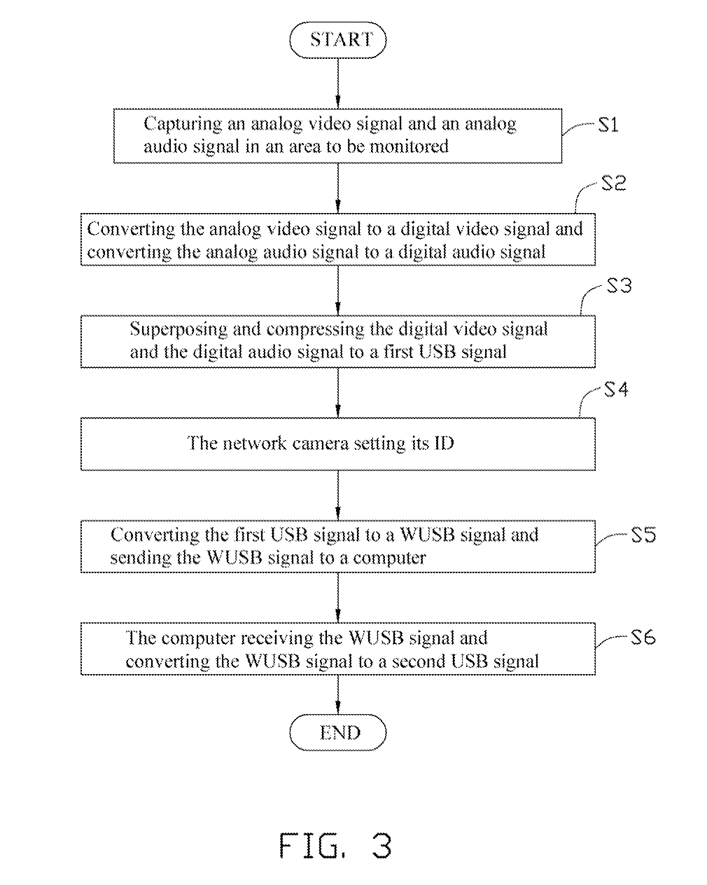

Referring to FIG. 3, an embodiment of a network A/V capturing method using the above-mentioned network A/V capturing system includes the following steps.

In step 1, the capturing unit 10 of the network camera 100 captures an analog video signal and an analog audio signal.

In step 2, the video converter 20 of the network camera 100 converts the analog video signal to a digital video signal; the audio converter 30 of the network camera 100 converts the analog audio signal to a digital audio signal.

In step 3, the microprocessor 40 of the network camera 100 superposes and compresses the digital video signal and the digital audio signal and outputs a first universal serial bus (USB) signal.

In step 4, the network camera 100 sets its ID. The network camera 100 sets its ID as “1” and detects the IDs of other network cameras 100 communicating with a computer 200. The network camera 100 repeatedly increments its ID by 1 if needed until its ID is unique.

In step 5, the signal sending unit 50 of the network camera 100 converts the first USB signal to a wireless USB (WUSB) signal and sends the WUSB signal, together with the camera ID, to the computer 200.

In step 6, the computer 200 receives the WUSB signal of the network camera 100 and converts the WUSB signal to a second USB signal. The second USB signal is decoded and converted to the analog video signal and analog audio signal.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A network camera, comprising:
a capturing unit to capture an analog video signal and an analog audio signal of an area to be monitored;
a video converter to convert the analog video signal to a digital video signal;
an audio converter to convert the analog audio signal to a digital audio signal;
a microprocessor to superpose and compress the digital video signal and the digital audio signal and outputs a first universal serial bus (USB) signal; and
a signal sending unit to convert the first USB signal to a wireless USB (WUSB) signal.

2. The network camera of claim 1, wherein the video converter is an analog-to-digital converter.

3. The network camera of claim 1, wherein the audio converter is an analog-to-digital converter.

4. The network camera of claim 3, wherein the signal sending unit is a radio apparatus.

5. A network audio/video capturing system, comprising:
a plurality of network cameras each comprising a capturing unit, a video converter, an audio converter, a microprocessor, and a signal sending unit, wherein the capturing unit captures an analog video signal and an analog audio signal of an area to be monitored, the video converter converts the analog video signal to a digital video signal, the audio converter converts the analog audio signal to a digital audio signal, the microprocessor superposes and compresses the digital video signal and the digital audio signal and outputs a first universal serial bus (USB) signal, the signal sending unit converts the first USB signal to a wireless USB (WUSB) signal;
a computer comprising a signal receiving unit and a processing unit, wherein the signal receiving unit receives the WUSB signal and converts the WUSB signal to a second USB signal, the processing unit converts the second USB signal to network data;
a server receiving and storing the network data; and
a plurality of network terminals to decode and convert the network data to the analog video signal and analog audio signal.

6. The network audio/video capturing system of claim 5, wherein the video converter is an analog-to-digital converter.

7. The network audio/video capturing system of claim 5, wherein the audio converter is an analog-to-digital converter.

8. The network audio/video capturing system of claim 5, wherein the signal sending unit is a radio apparatus.

9. A method for capturing network audio/video, the method comprising:
capturing an analog video signal and an analog audio signal of an area to be monitored by a network camera of a plurality of network camera;
converting the analog video signal to a digital video signal and converting the analog audio signal to a digital audio signal;
superposing and compressing the digital video signal and the digital audio signal to output a first universal serial bus (USB) signal;
converting the first USB signal to a wireless USB (WUSB) signal and sending the WUSB signal to a computer; and
the computer receiving the WUSB signal and converting the WUSB signal to a second USB signal.

10. The method of claim 9, further comprising the network camera setting its identification (ID) before sending the WUSB signal to the computer, wherein the network camera setting its ID comprises:
the network camera setting its ID as “1”;
the network camera detecting IDs of other network cameras communicating with the computer;
the network camera adding its ID by 1 if there is an ID equaling to the ID of the network camera until its ID is unique.
